(19) United States
(12) Patent Application Publication
(10) Pub. No.: US 2023/0000187 A1
(43) Pub. Date: Jan. 5, 2023

(54) N95 Nose Mask

(71) Applicant: Orlando P. Gonzaga, Waipahu, HI (US)

(72) Inventor: Orlando P. Gonzaga, Waipahu, HI (US)

(21) Appl. No.: 17/367,418

(22) Filed: Jul. 5, 2021

(51) Int. Cl. A41D 13/11; A62B 23/06

(52) U.S. Cl. CPC A41D 13/1169; A62B 23/06

(57) ABSTRACT

A PPE (Personal Protective Equipment) designed to enclose the nose region while allowing the mouth open for various daily activities and events.

### FIELD

The present application relates to facial masks that filters out debris and alienated particles that poses health hazards.

### BACKGROUND

As the result of the Corona virus pandemic (Covid19), CDC issued a recommendation of social distancing, limiting social gatherings and use of facial masks. Social fear and businesses were highly affected. The use of facial masks, although an effective means of protection from the virus and alienated particles, such as dust and pollen prove taxing. Heat permeates from intake and out take breathing. Thus, becomes problematic during daily exercise, routines, and daily schedules.

My proposed invention focuses on the nostrils or the nose region. Leaving the mouth clear to talk, eat, drink and or smoke, as examples.

### SUMMARY

By creating a healthier avenue for breathing and focusing on the nostrils where they bifurcate to the external openings. The nostrils either of the two external openings of the nasal cavity admits oxygen to the lungs and smells to the olfactory nerves will have a mask to help filter contaminants and/or alienate debris.

This proposed safety nose mask will have a ventilator outtake valve located below the openings of the nostrils. The ventilator will prevent the collection of outtake heat, thus creating a cooler and comfortable breathing experience. As it is known, breathing of ones own carbon dioxide is a slow poison and will show some problematic effect on ones health.

### BRIEF DESCRIPTION OF THE DRAWINGS

In the following detailed portion of the present description. The teachings of the present application will explain various changes and addition without deletion of functionality.

### Drawing:

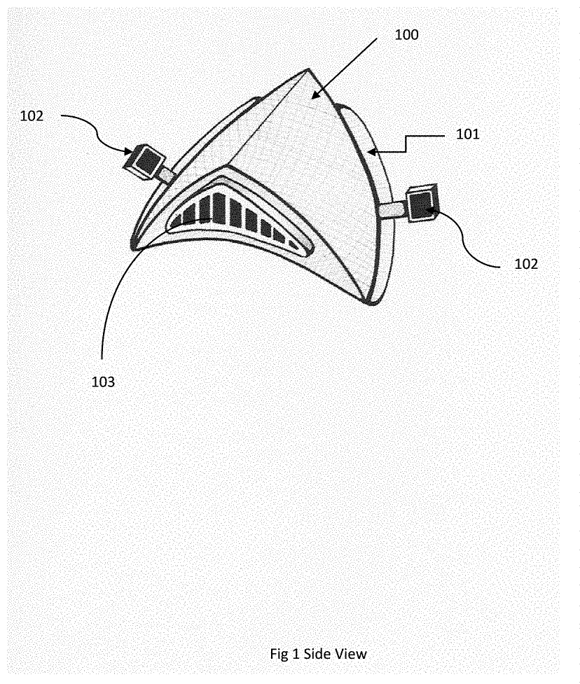

FIG. 1 is a side view depiction of its shape and form.

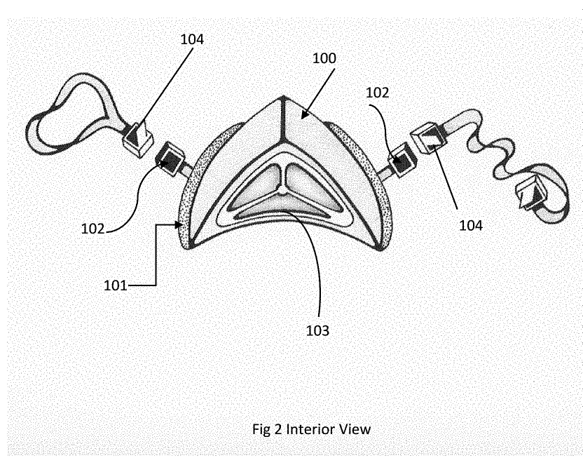

FIG. 2 is an interior view of its functional properties.

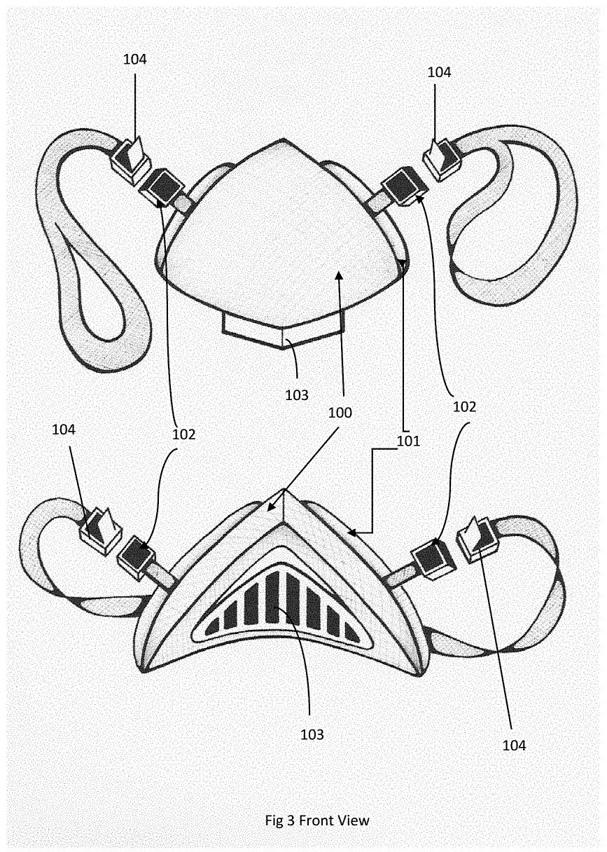

FIG. 3 is a frontal view depiction and interchangeable head wear (portrayed as an optional desired design preference).

### DETAILED DESCRIPTION

In the following description, the PPE (Personal Protective Equipment) according to the teachings for this application in the form of a safety nose mask as illustrated in FIGS. 1,2 and 3 depicted illustration 100. Material construction would be that of N95: An electrostatic non-woven polypropylene fiber.

In the following description shown in FIG. 1, the side view will depict same aspects as shown on FIG. 3 frontal illustrated image.

The PPE safety nose mask is designed to only encase the nose region of the face. Its designed concept carries its functionality like a full facial safety mask (as illustrated on FIGS. 1 and 3). The proposed PPE not only provides protection from alienated particles like dust debris, pollen, and/or exposure from foreign viruses. But, it also allows the user in having complete usage of the persons mouth. For example, with the proposed PPE, an individual could have dinner, attend sport events, have doctor or dental visits, and use in construction.

In the following description shown in FIG. 2 the proposed PPE has facial adhesive wings depicted in illustration 101. The facial adhesive wings material is based on body adhesives currently in market today (Medical Grade Tape) clear in color. This will allow the user to peel and stick it on their face without the need of ear straps or head straps depicted in FIG. 1. Thus, allowing the user as an example, cut their hair leaving the ear or head free from unwanted straps.

In the following description depicted in FIGS. 1, 2, and 3 the proposed PPE safety nose mask has a female cord insert clips depicted in illustration 102. Allowing the user to insert and alternate head wear/ear wear straps as depicted in illustration 104 on FIGS. 2 and 3. Material based on elastic clothing bands in market today.

In the following description depicted in FIGS. 1, 2 and 3 the proposed PPE safety nose mask has an over sized ventilator below the nostrils as illustrated 103. Material based on breathing ventilator in market today, a rubberized thin material with flexibility. This will allow the passage of hot respiratory air to vent out, allowing comfortable breathing and eliminate the intake of carbon dioxide into the lungs and blood streams. Inhalation at low concentrations are not harmful. Higher concentrations can affect respiratory function and because excitation followed by depression of the central nervous system. A high concentration can displace oxygen in the air. “Carbon dioxide poisoning”.

1. A PPE (Personal Protective Equipment), designed to utilize the nose region of the face. As illustrated on FIGS. 1, 2 and 3 depicted 100.

2. A PPE designed to utilize the nose region of the face that can adhere to the face by means of adhesive wings located on either side of the nose. Allowing the user free from using an elastic head or around the ear wear. As illustrated in FIGS. 1, 2, and 3 depicted 101.

3. A PPE designed to utilize the nose region of the face that has an outtake ventilator just below the nostrils as a direct means for hot respiratory to vent out. As illustrated in FIGS. 1, 2, and 3 depicted 103. Most PPE respirators or masks usually has its ventilator mounted on the side and or on the top front.

4. A PPE designed to utilize the nose region of the face has female and male clips. This will allow the user to inter-change desired elastic straps as means for facial wear, alternating from head elastic wear to an elastic around the ear wear. As illustrated in FIGS. 1, 2 and 3 depicted 102 and 104.
